(19) United States
(12) Patent Application Publication
(10) Pub. No.: US 2003/0062394 A1
(43) Pub. Date: Apr. 3, 2003

(54) Cover on nozzle assembly for pneumatic nilers

(76) Inventor: Kuan-Lin Wang, (US)

Correspondence Address: Charles E. Baxley, 5th Floor, 59 John Street, New York, NY, 10038, US

(21) Appl. No.: 09/967,397

(22) Filed: Oct. 1, 2001

(51) Int. Cl. B25C 5/02

(52) U.S. Cl. 227/123; 227/127

(57) ABSTRACT

A nozzle assembly for a pneumatic tool includes a base connected to a magazine and a rod extends from the base. A cover is pivotally connected to the base and a notch is defined in a side of the cover. A retaining member has a passage defined in an intermediate portion thereof so as to receive the rod therein. A spring is biased between a first end of the retaining member and the base. A second end of the retaining member has a hook which is disengagably engaged with the notch. The cover can be pivoted away from the base by releasing the hook from the notch so that the cover will not loose.

### FIELD OF THE INVENTION

The present invention relates to a cover pivotally connected to a top of a nozzle assembly of a pneumatic nailer and a retaining member is disengagably hooked to the cover so that the cover will not separate from the magazine when being maintained.

### BACKGROUND OF THE INVENTION

A conventional pneumatic nailer generally includes a magazine for receiving nails therein and a nozzle assembly is connected to a top of the magazine. A cover is disengagably connected to the nozzle assembly by a quick-release device so that when the nails are jammed or stocked, the user pulls the quick-release device to remove the cover from the nailer and access the nails in the magazine. The cover is then put aside when trying to resolve the problems of the magazine. The cover is a small piece so that it could mixed with other objects and is not easily found after the problems are resolved.

### SUMMARY OF THE INVENTION

In accordance with one aspect of the present invention, there is provided a nozzle assembly for a pneumatic tool and the nozzle assembly comprises a base connected to a magazine and has a slot defined through. A rod extends from the base so that a retaining member is pivotally connected to the rod. A cover has an end thereof pivotally connected to the base and a notch is defined in a side of the cover. A spring is biased between a first end of the retaining member and the base. A second end of the retaining member has a hook which is disengagably engaged with the notch.

The primary object of the present invention is to provide a nozzle assembly wherein the cover is pivotally connected to the base so that the cover can be pivoted to allow the user to access the nails in the base.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the nozzle assembly of the present invention;

FIG. 2 is an end view to show that the hook of the retaining member is engaged with the notch of the cover;

FIG. 3 is an end view to show that the hook of the retaining member is pivoted away from with the notch of the cover, and

FIG. 4 is an end view to show that the cover is pivoted away from the base of the nozzle assembly of the present invention.

### DETAILED DESCRIPTION OF THE PREFERRED EMBODIMENT

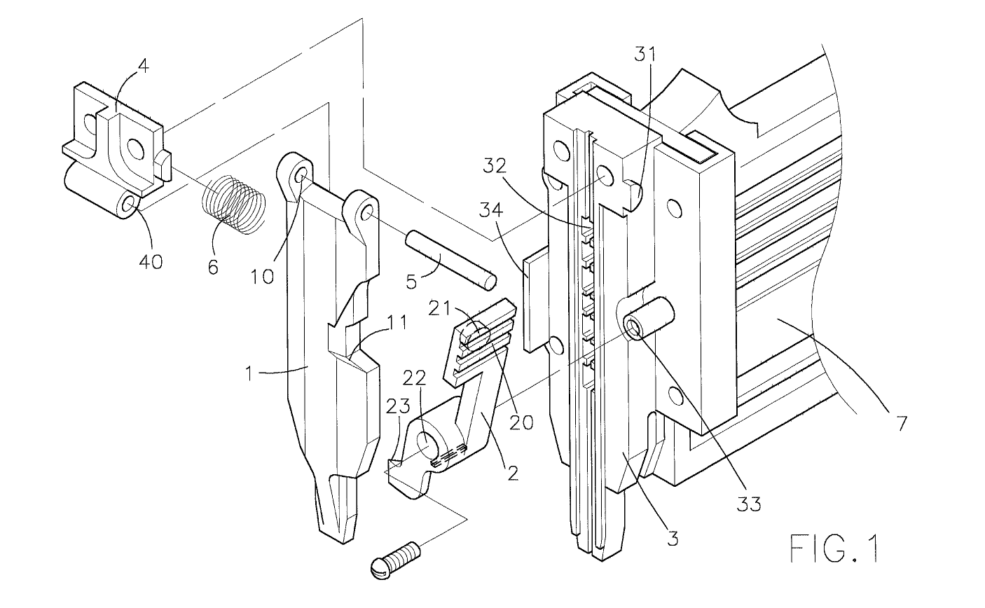

Referring to FIGS. 1 and 2, the nozzle assembly of a pneumatic nailer of the present invention comprises a base 3 connected to a magazine 7 and has a slot 32 defined through so that an ejection piece (not shown) can move into the slot 32 to eject the nails (not shown) in the magazine 7. A rod 33 and a guide plate 34 respectively extend from the base 3 and located on two opposite sides of the slot 32. A plate 4 is fixedly connected to the base 3 and a tube 40 is connected to the plate 4.

A cover 1 has two lugs 10 and the tube 40 is located between the two lugs 10. A pin 5 extends through the two lugs 10 and the tube 40 so that the cover 1 is pivotally connected to the base 3. A wedge-shaped notch 11 is defined in a first side of the cover 1.

A retaining member 2 has a passage 22 defined in an intermediate portion thereof and the rod 33 is engaged with the passage 22. A spring 6 is biased between a protrusion 21 on a first end of the retaining member 2 and a protrusion 31 on the base 3. A second end of the retaining member 2 has a hook 23 which is disengagably engaged with the notch 11 so as to position the cover 1. A second side of the retaining member 2 contacts the guide plate 34 to prevent the cover 1 from shaking during operation.

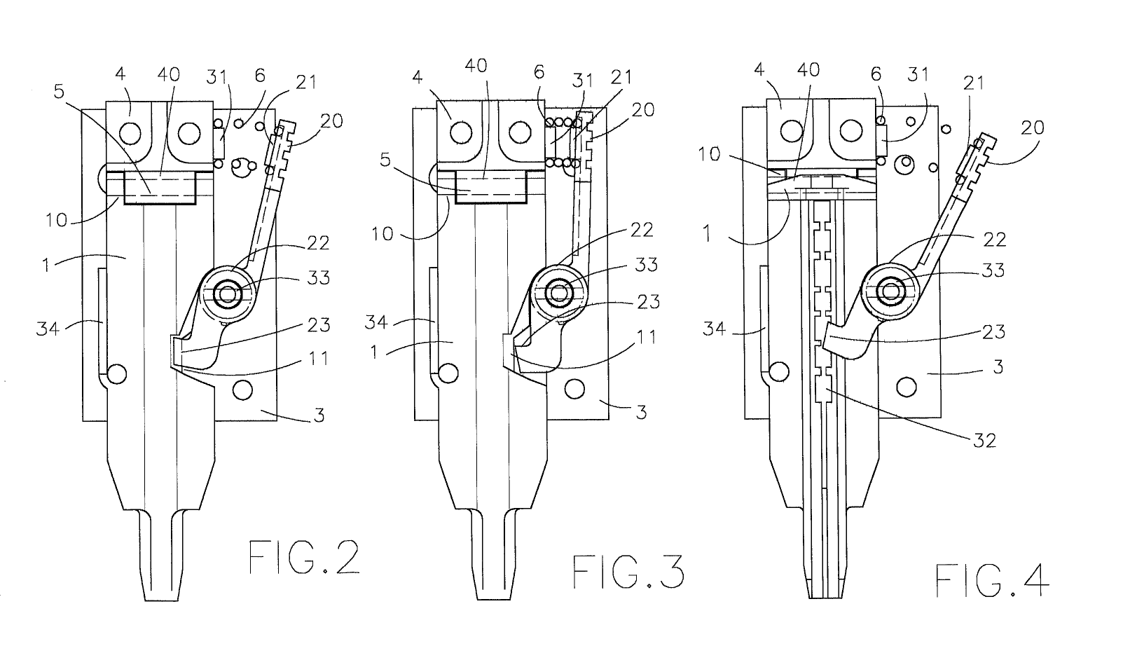

Referring to FIGS. 3 and 4, when the user wants to access the nails in the slot 32, he/she simply pushes the first end of the retaining member 2 to remove the hook 23 from the notch 11, and then pivoting the cover 1 away from the base 3 as shown in FIG. 4. The user conveniently accesses the nails in the slot 32 and the cover 1 is still connected to the base 3.

By the nozzle assembly of the present invention, the cover 1 will not loose while the user accesses the nails in the slot 32.

While we have shown and described the embodiment in accordance with the present invention, it should be clear to those skilled in the art that further embodiments may be made without departing from the scope of the present invention.

What is claimed is:

1. A nozzle assembly for a pneumatic tool, comprising:
a base adapted to be connected to a magazine and having a slot defined through, a rod extending from said base;
a cover having an end thereof pivotally connected to said base and a notch defined in a side of said cover, and
a retaining member having a passage defined in an intermediate portion thereof and said rod engaged with said passage, a spring biased between a first end of said retaining member and said base, a second end of said retaining member having a hook which is disengagably engaged with said notch.

2. The nozzle assembly as claimed in claim 1, wherein said base has a guide plate extending therefrom and the other side of said retaining member contacts said guide plate.

3. The nozzle assembly as claimed in claim 1 further comprising a plate fixedly connected to said base and a tube connected to said plate, said cover having two lugs and said tube located between said two lugs, a pin extending through said two lugs and said tube.
